(19) United States
(12) Patent Application Publication
(10) Pub. No.: US 2006/0150523 A1
(43) Pub. Date: Jul. 13, 2006

(54) Sealing strip for a vehicle frame structure

(75) Inventor: Ingolf Matthies, Altenau (DE)

Correspondence Address: SYNNESTVEDT & LECHNER, LLP, 2600 ARAMARK TOWER, 1101 MARKET STREET, PHILADELPHIA, PA, 191072950, US

(73) Assignee: Meteor Gummiwerke K.H. Badje GmbH & Co., KG, Bockenem (DE)

(21) Appl. No.: 10/547,198

(22) PCT Filed: Feb. 11, 2004
(86) PCT No.: PCT/EP04/01251

§ 371 Date: Aug. 26, 2005

(30) Foreign Application Priority Data
Mar. 18, 2003 (DE) 203 04 270.0

(51) Int. Cl. E06B 7/16

(52) U.S. Cl. 49/495.1; 49/475.1

(57) ABSTRACT

A sealing strip which is arranged for mounting on a vehicle frame structure and which is intended to cooperate with a window pane which can be pivoted between an open and a closed position is characterized by a U-shaped basic body which consists of two L-shaped molded parts (1, 2) which are produced separately from each other, can be connected together and in the connected state form the basic body of the sealing strip, wherein at least one of the molded parts (1, 2) comprises a functional surface which is to be coated or is to be processed in another manner. The basic body has an elongated structure which surrounds a hollow space (26) and whose free ends are provided in each case with a sealing lip (11, 21) which is intended to lie against the pane during the pivoting movement of said pane which is introduced on the edge-side into the hollow space (26). The sealing strip comprises a configuration which is two-dimensionally or spatially curved in dependence upon the vehicle frame structure and, starting from one end towards the other end, the hollow space (26) has a changing depth corresponding to a width dimension (8). As a result of the division into two molded parts (1, 2), it is possible to coat or otherwise process the said functional surfaces in a problem-free manner in particular also with consideration given to the different insertion depths of the pane in the longitudinal direction of the sealing strip.

The invention relates to a sealing strip according to the preamble of claim 1.

Sealing strips of this type are used in the C-pillar region of vehicle structures but also in the region of the roof frames of folding roof covers, hardtops and retractable hardtops. In all cases, a pane which can be moved, in particular pivoted, between an open and a closed position is provided and in the closed condition is in engagement with the sealing elements of this sealing strip, wherein this engagement is released in the open condition and wherein partial engagement is achieved according to the open or pivot position of the pane.

In the structural design of the pivoting movement of the pane, it is necessary in dependence upon the respective vehicle design to observe geometric restrictions which are often caused by the wheel case which restricts the space available inside the door construction to receive the pane in the fully open condition. Therefore, in many cases it is necessary to arrange a comparatively complicated pivoting movement of the pane, a situation which must be observed when dimensioning the sealing strips. Sealing strips of this type are regularly formed in such a manner that they serve as a support for two sealing lips which are intended to cover edge regions of the pane in a sealing manner on both sides, wherein the two-dimensional or spatial progression of the sealing strip is to be adapted to the pivoting movement of the pane in order to achieve coverage with the sealing lips which is uniform in the sealing region.

Therefore, the sealing strip which is ready for mounting on a vehicle is a component which is curved in a two-dimensional or spatial manner in dependence upon the specific application and supports two sealing lips.

Within the Applicant's firm, it is known to form this component in one piece, wherein a distinction is made between a basic structure and the sealing lips which are different in terms of materials and wherein in order to improve the sealing properties and to reduce wear the surface portions of the sealing lips which interact with the pane are coated e.g. with an antifriction varnish. Further surface processing can be performed in diverse flocking methods etc. Since the surfaces which are to be processed are frequently located at points on the sealing strip which are difficult to reach and since elastic deformation is generally required for the purpose of exposing the surfaces which are to be processed, these working operations are frequently difficult to perform in particular by reason of the spatially curved configuration of the sealing strip in conjunction with the width dimensions which are not constant along this strip. The poor accessibility to these functional surfaces can, in individual cases, lead to reductions in quality in processing and to defects in the end products.

Against this background, it is the object of the invention to design a sealing strip of the type described in the introduction which simplifies working processes in the region of the functional surfaces whilst obviating the disadvantages associated with the prior art and which, by adaptation to the respective pivot curve of the pane, permits any insertion depth between the pane and the sealing strip according to variable coverage of the sealing surfaces of the pane. In the case of a sealing strip of this type, this object is achieved by the features of the characterizing part of claim 1.

According to this it is essential to the invention that the sealing strip consists of two mutually separate molded parts which can be connected together and extend e.g. in a uniform manner from one end to the other end. Both molded parts are finish-processed prior to assembly, in particular in the region of their functional surfaces and are only connected together in the end state in order to form the completed sealing strip. In the case of this construction, the molded parts can be constructed with particular consideration given to the importance of manufacturing technology which affects in particular the functional surfaces which require finish-processing, in particular in the form of a coating procedure or other procedure. These finishing procedures can thus be performed unhindered by the structure of the completed sealing strip and furthermore independently of the two-dimensional or spatial curvature of the molded part which is caused by the specific vehicle frame construction and the pivot curve of the pane. Therefore, as a result a sealing strip is provided which by reason of its structural design is free of processing errors and is characterized, in terms of quality, by faultless processing of its functional surfaces.

The features of claims 2 to 4 are directed to the most frequent type of sealing strip which has a U-shaped cross-section, wherein sealing lips are attached to the free ends of this U-shaped structure and wherein the hollow space which is surrounded by this structure is intended to receive the pane during the pivoting movement thereof starting from the closed position to the open position. This hollow space comprises a configuration which is governed by the pivot curve of the pane and changes in the longitudinal direction of the sealing strip, and said hollow space permits in particular different insertion depths of the pane starting from one end to the other end of the sealing strip. Finally, this hollow space is also curved in a two-dimensional or spatial manner and, in turn, in accordance with the respective vehicle design. At the same time, this basic structure exemplifies the difficulty which would otherwise arise during the processing of functional surfaces within this structure. Functional surfaces are considered in particular to be those surfaces which come into direct contact with edge regions of the pane which is introduced into this structure during the said pivoting movement.

In accordance with the features of claims 5 to 7, the molded parts in accordance with the invention comprise a generally L-shaped configuration which is composed, on the one hand, of a mounting portion and, on other hand, of a side portion, wherein attached to the free ends of the mounting portions are sealing elements which support the sealing lips.

Both molded parts can be assembled in this manner with their mounting portions to produce a configuration which is rectangular or even square in cross-section, so that a structure of a sealing strip is formed which has a U-shaped cross-section.

In accordance with the features of claim 8, the sealing lips comprise an arcuate configuration and, starting from the free ends of the U-shaped structure, extend inwards in relation to the hollow space defined thereby. Preferably, the sealing lips contact each other when the pane is pivoted out within this hollow space. This means that when the pane is pivoted in, the sealing lips are elastically pivoted as a result of the lips lying against the pane, whereby in dependence upon the extent of the pivoting movement an elastic contact force is applied. By appropriately coating the surfaces of the sealing lips, it is possible in particular to improve their antifriction properties and any occurring wear and friction forces with respect to the pane are reduced. The elastic restoring force of the sealing lips can be influenced in structural terms by the selection of the material but also by local cross-sectional attenuations, notches or the like.

The features of claims 9 to 11 are directed to exemplary embodiments of the sealing strip in terms of materials. Accordingly, the molded parts can consist e.g. of a glass fiber-reinforced PPE, wherein the sites which are intended for injection molding of sealing elements which can consist e.g. of EPDM are coated with SBR. All of these parts are preferably processed by extrusion, injection molding or transfer molding, therefore substantially within the scope of continuous manufacturing methods, wherein functional surfaces are subjected to finish-processing, in particular a coating procedure. However, the material data is provided merely by way of example and is not to be understood as a limitation thereto. For example, a PPE with a glass fiber proportion of 20% and an EPDM with a Shore A hardness of 50 can be used.

In accordance with the features of claim 12, the molded parts are attached to each other in a positive-locking manner. The sealing element arrives at the assembly line in this state, in which the molded parts are attached to each other. It is thus a component which can be handled uniformly.

In accordance with the features of claim 13, functional surfaces of the sealing strip are coated e.g. with an antifriction varnish or flocked.

In accordance with the features of claim 14, the mounting portions of both molded parts are intended to overlap in the assembled state and accordingly to be provided in the surface region with positive locking elements which are brought into engagement during assembly. In essence, these locking elements can actually be configured in any way, as long as a reliable connection, in particular also a locking connection, is provided.

It can be appreciated that the sealing strip in accordance with the invention is a product which is configured in particular with regard to the interests of manufacturing and which permits adapted coverings in the sealing region according to the pivot position of a pane, and moreover with adaptation to any two-dimensional or spatial curvatures which are determined by the respective vehicle frame construction, so that corresponding to the pivot angle of the pane, variable insertion depths of the pane into the structure of the sealing strip are permitted.

The invention will be described in detail hereinunder with reference to the exemplified embodiment which is illustrated schematically in the drawings, in which

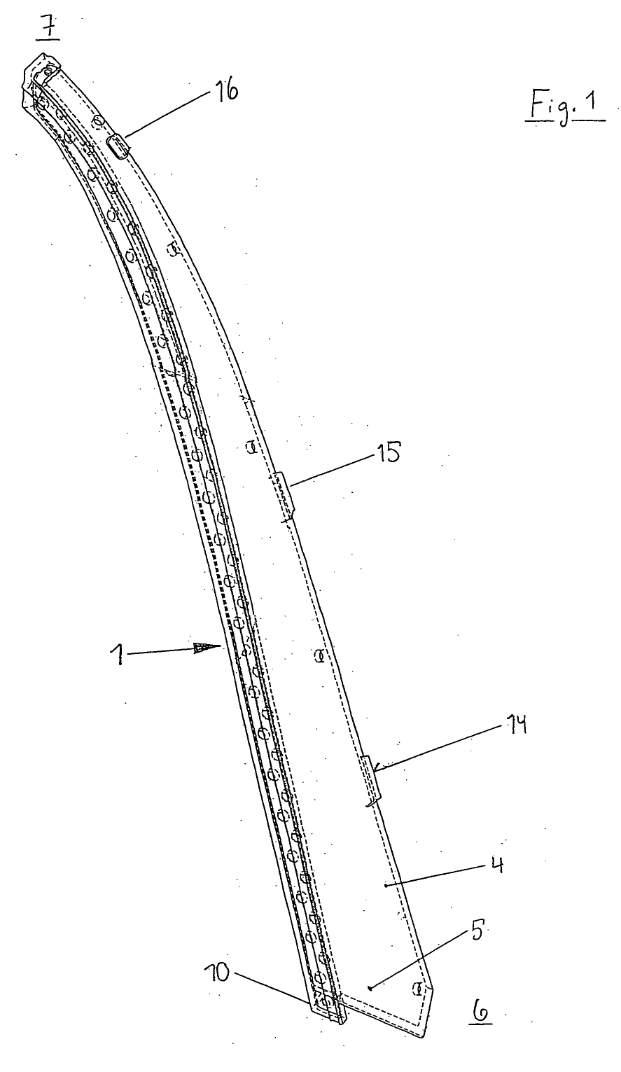

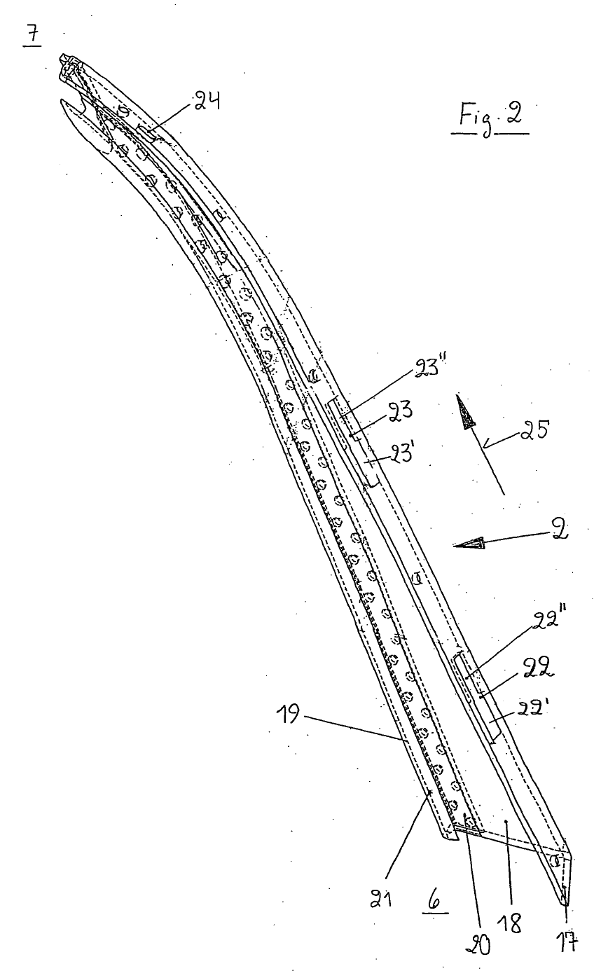

FIGS. 1 and 2 show in each case perspective illustrations of the mutually adapted molded parts which cooperate with each other within the framework of the sealing strip in accordance with the invention;

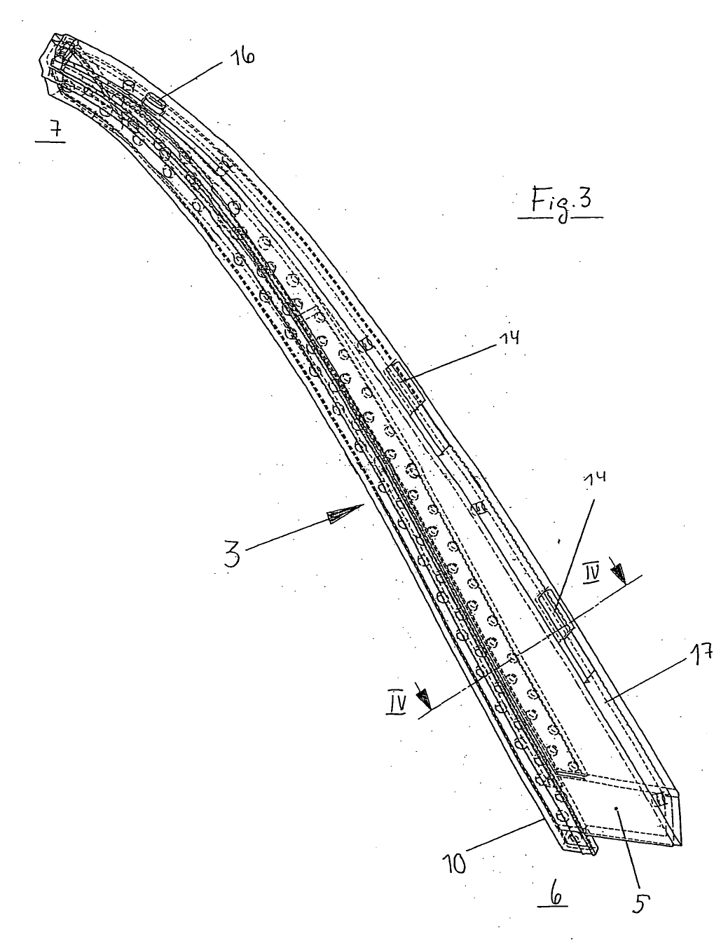

FIG. 3 shows a perspective illustration of the completed sealing strip in accordance with the invention;

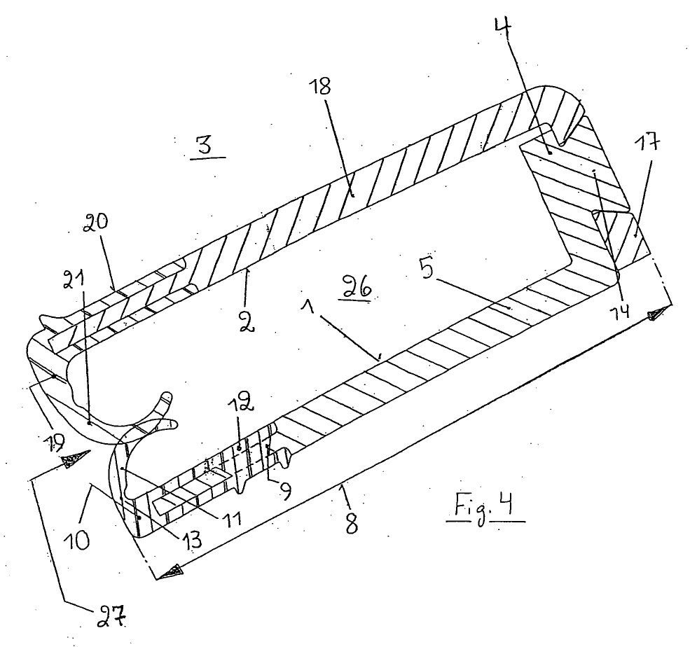

FIG. 4 shows a sectional view of the sealing strip taken along a sectional plane IV-IV of FIG. 3.

The reference numerals 1, 2 designate two molded parts which can be assembled to form a sealing strip 3 in accordance with the invention and are provided in this assembled state for mounting on a vehicle.

The molded part 1 comprises a generally L-shaped configuration which is angular in cross-section and is made up of a relatively narrower mounting portion 4 and a side portion 5 which extends perpendicularly thereto. Starting from its one end 6 to its other end 7, the molded part 2 comprises a spatially curved configuration which is adapted to the contour of the window of a vehicle in the region of its C-pillar, wherein starting from the end 6 in the direction towards the other end 7, the side portion 5 also comprises a decreasing width dimension 8.

In the vicinity of its free end, the side portion 5 is provided with a linear arrangement of bores 9 which are arranged in such a manner as to be distributed uniformly over its entire length. These bores serve to secure in a positive-locking manner a sealing element 10 which is applied in an injection molding method and on which there is integrally formed a sealing lip 11 which extends in an arcuate manner inwards in relation to the angular profile of the molded part 1.

The part of the side portion 5 which faces the free end of the molded part 1 and is connected directly to the sealing element 10 is formed in a tapered manner in relation to its wall thickness, wherein a base portion 12 of the sealing element 10 which extends in the plane of the side portion 5 corresponds in terms of its wall thickness to that of the side portion 5 and on the whole a uniform wall thickness of the side portion 5 is provided up to the starting point of the sealing lip 11. The sealing lip 11 is integrally formed directly on to the free end of this base portion 12, with a notch 13 positioned therebetween. Because of this notch 13 in particular, the sealing lip 11 is able to deform elastically towards the inner side, i.e. in the direction towards the base portion 12.

The reference numerals 14 to 16 designate block-like profile elements which protrude from the outer side of the mounting portion 4 and in a cross-section—as seen in the longitudinal direction of the mounting portion 4 - comprise a shape extending conically towards the outer side and which profile elements serve to fix the molded part 1 in a positive-locking manner to the molded part 2 in a manner to be explained hereinunder. The reference numeral 16 designates a further profile element which protrudes from the surface of the mounting portion 4.

The molded part 1 consists e.g. of glass fiber-reinforced PPE which is coated with SBR in the region of the bores 12, namely the end portion which has a reduced wall thickness. The sealing element 10 is produced with the aid of a molding tool in an injection molding method and can be produced from EPDM.

The molded part 2 which is illustrated in FIG. 2 likewise comprises a generally angular, L-shaped basic configuration and consists of a comparatively narrow mounting portion 17, towards which a side portion 18 extends at a right angle. A sealing element 19 which likewise extends over the entire length of this molded part 2 is attached to the free end of the side portion 18 in a comparable manner to the molded part 1. For this purpose, a part which is adjacent to the free end of this side portion 18 is reduced in terms of wall thickness and is provided with a uniform distribution of bores which serve to fix a base portion 20 of the sealing element 19 in a positive-locking manner. The part of the side portion 18 which has a reduced wall thickness is dimensioned so as to be adapted to the said base portion 20 such that—as in the case of the molded part 1 - the wall thickness of the side portion 18 progresses on the whole in a constant manner in this region. In turn, a sealing lip 21 is integrally formed on the base portion 20 and moreover on the free end of the side portion which extends in an arcuate manner inwards in relation to the L-shaped profile of the molded part 2.

In terms of materials, the configuration of the molded part 2 can be the same as that of the molded part 1.

The reference numerals 22, 23 designate continuous cut-outs in the mounting portion 17 which are disposed at a spaced interval from one another and are configured in an identical manner. They consist in each case of a first portion 22′, 23′ which is rectangular in the plan view and whose walls extend perpendicularly to the outer surface of the mounting portion 17, and of a second portion 22″ or 23″ which adjoins in the direction towards the end 7 and which—as seen in cross-section—as shown in particular in FIG. 4—comprises a configuration which is complementary to the profile element 14. This means that the portions 22″, 23″ widen conically towards the outer side.

The reference numeral 24 designates a further cut-out in the mounting portion 17 which is located on the part of the molded part 2 which is adjacent to the end 7.

As shown with reference to FIG. 3 and 4, the two molded parts 1, 2 are intended to connect together in a positive-locking manner and in this assembled state are intended to form a ready-to-install sealing element 3. In order to assemble the two molded parts 1, 2 together, they are placed one inside the other with the proviso that initially the profile elements 14, 15 are inserted into the portions 22′, 23′ of the mounting portion 17 intended for this purpose and are then displaced in the longitudinal direction of this mounting portion 17, i.e. in the direction of the arrow 25 until they are received in the parts 22″, 23″ and secured in a positive-locking manner. This displacement movement can be secured further by means of mechanical locking or even by frictional engagement. This is performed by the profile element 16 which locks with the cut-out 24 and forms a positive-locking feature to prevent a displacement of the molded parts 1, 2 in the opposite direction to the arrow 25. In this assembled state, the two molded parts 1, 2 surround a hollow space 26 which generally has a rectangular configuration whose narrow side is determined by the width of the mounting portions 4, 17 and whose longitudinal side is determined by the width dimension 8 or the width of the side portions 5, 18. This means that starting from one end 6 to the other end 7, the cross-section of this hollow space changes steadily from a maximum dimension to a minimum dimension which in particular affects the width dimension 8. Furthermore, this hollow space is spatially curved in the manner in which it is predetermined by the identical curvatures of the molded parts 1, 2 whose specific configuration is dependent upon the respective application.

It is essential that the two sealing lips 11, 21 of the two sealing elements 10, 20 extend in the direction towards each other and—as also shown in FIG. 4—lie against each other which can occur under elastic pretensioning. These two sealing lips 11, 21 can have completely identical dimensions—however, any deviations, as shown in FIG. 4 of the drawings, are similarly possible.

It is essential that the sealing element 3 is attached e.g. in the region of the C-pillar of a vehicle structure with the proviso that a pane which can be moved between an open and a closed position can be introduced into the hollow space 26 in the direction of the arrow 27, i.e. approximately in a central region by the elastic displacement of the two sealing lips 11, 21, wherein in the introduced state, the two sealing lips 11, 21 lie flat against both sides of the pane in order to perform a sealing function. In this case, both sealing lips 11, 21 are deflected from the position shown in FIG. 4 in an elastic manner in the direction towards the respective base portion 12, 20, whereby an elastic contact force is generated which maintains the sealing function.

The sealing strip in accordance with the invention is formed in a spatially curved manner, permits variable coverage of a pane and is suitable for virtually any movement curves of panes by reason of its insertion depth which is to be tailored individually, in particular the course of the cross-section of the hollow space 26.

In particular, the two-part configuration of this sealing element permits qualified, hindrance-free surface processing possibilities, such as e.g. applying an antifriction varnish, flocking etc.

1. Sealing strip (3) which is arranged for mounting on a vehicle frame structure and which is intended to cooperate with a window pane which can be pivoted between an open and a closed position, having a basic body which comprises an elongated structure which has a U-shaped cross-section and substantially surrounds a hollow space (26), wherein a sealing lip (11, 21) is disposed in each case on the free ends of this structure with the proviso that the pane which is introduced on the edge-side into the hollow space (26) during a pivoting movement comes into abutment on both sides with a sealing lip, having two molded parts (1, 2) which are produced separately from one another, can be connected together and in the connected state form the basic body of the sealing strip (3), wherein both molded parts consist of a synthetic material, comprise a generally L-shaped configuration and consist in each case of a mounting portion (4, 17) and a side portion (5, 18) which extends preferably perpendicularly thereto, and that in the mounted state the molded parts (1, 2) overlap in the region of their mounting portions (4, 17), characterized in that the basic body comprises a configuration which is two-dimensionally or spatially curved in dependence upon the vehicle frame structure, that, starting from one end (6) towards the other end (7), the hollow space (26) comprises a changing, in particular a reducing depth corresponding to a width dimension (8), that profile elements (14, 16), which can be brought into engagement with cut-outs (22, 23) in the mounting portion (17) in order to attach the molded parts in a positive-locking manner to each other, are integrally formed on the mounting portion (4), and that a sealing element (10, 19) which supports a sealing lip (11, 21) and is produced from an elastomer is attached to each free end of the side portions (5, 18) of the molded parts (1, 2).

2. Sealing strip (3) as claimed in claim 1, characterized in that at least one of the molded parts (1, 2) comprises a functional surface which is to be coated or processed in another way, and that the functional surface is located within the U-shaped structure of the hollow space (26).

3. Sealing strip (3) as claimed in claim 1, characterized in that the sealing lips (11, 21) comprise an arcuate configuration and preferably contact each other within the hollow space (26) when the pane is pivoted out.

4. Sealing strip (3) as claimed in claim 1, characterized in that the molded parts (1, 2) consist of a fiber-reinforced PPE [poly(oxy-(2,6-dimethyl)-1,4-phenylene)].

5. Sealing strip (3) as claimed in claim 1, characterized in that the sealing elements (10, 19) consist of EPDM (ethylene/propylene-diene-copolymer), TPE (thermoplastic elastomer) or the like.

6. Sealing strip as claimed in claim 1, characterized in that at least the regions of the molded parts (1, 2) which during production of the sealing elements (10, 19) by injection-molding interact with these sealing elements, are coated with SBR (styrene-butadiene-rubber) or a comparable substance.

7. Sealing strip (3) as claimed in claim 2, characterized in that the said functional surfaces are coated with an antifriction varnish, are flocked or are processed in another way in the surface region.

8. Sealing strip (3) as claimed in claim 1, characterized in that in the mounted state the molded parts (1, 2) are connected together via positive locking elements which are formed in these portions.

9. Sealing strip (3) as claimed in claim 2, characterized in that the sealing lips (11, 21) comprise an arcuate configuration and preferably contact each other within the hollow space (26) when the pane is pivoted out.

10. Sealing strip (3) as claimed in claim 2, characterized in that the molded parts (1, 2) consist of a fiber-reinforced PPE [poly(oxy-(2,6-dimethyl)-1,4-phenylene)].

11. Sealing strip (3) as claimed in claim 2, characterized in that the sealing elements (10,19) consist of EPDM (ethylene/propylene-diene-copolymer), TPE (thermoplastic elastomer) or the like.

12. Sealing strip as claimed in claim 2, characterized in that at least the regions of the molded parts (1, 2) which during production of the sealing elements (10, 19) by injection-molding interact with these sealing elements, are coated with SBR (styrene-butadiene-rubber) or a comparable substance.

13. Sealing strip (3) as claimed in claim 3, characterized in that the said functional surfaces are coated with an antifriction varnish, are flocked or are processed in another way in the surface region.

14. Sealing strip (3) as claimed in claim 2, characterized in that in the mounted state the molded parts (1, 2) are connected together via positive locking elements which are formed in these portions.

15. Sealing strip (3) as claimed in claim 3, characterized in that the molded parts (1, 2) consist of a fiber-reinforced PPE [poly(oxy-(2,6-dimethyl)-1,4-phenylene)].

16. Sealing strip (3) as claimed in claim 3, characterized in that the sealing elements (10, 19) consist of EPDM (ethylene/propylene-diene-copolymer), TPE (thermoplastic elastomer) or the like.

17. Sealing strip as claimed in claim 3, characterized in that at least the regions of the molded parts (1, 2) which during production of the sealing elements (10, 19) by injection-molding interact with these sealing elements, are coated with SBR (styrene-butadiene-rubber) or a comparable substance.

18. Sealing strip (3) as claimed in claim 4, characterized in that the said functional surfaces are coated with an antifriction varnish, are flocked or are processed in another way in the surface region.

19. Sealing strip (3) as claimed in claim 3, characterized in that in the mounted state the molded parts (1, 2) are connected together via positive locking elements which are formed in these portions.

20. Sealing strip (3) as claimed in claim 4, characterized in that the sealing elements (10, 19) consist of EPDM (ethylene/propylene-diene-copolymer), TPE (thermoplastic elastomer) or the like.
